(19) United States
(12) Patent Application Publication
(10) Pub. No.: US 2013/0233697 A1
(43) Pub. Date: Sep. 12, 2013

(54) Process for Water Treatment and Generation

(71) Applicant: HALLIBURTON ENERGY SERVICES, INC., Houston, TX (US)

(72) Inventor: Jason Bryant, Houston, TX (US)

(73) Assignee: HALLIBURTON ENERGY SERVICES, INC., Houston, TX (US)

(21) Appl. No.: 13/789,937

(22) Filed: Mar. 8, 2013

Related U.S. Application Data
(60) Provisional application No. 61/608,833, filed on Mar. 9, 2012.

(51) Int. Cl. C02F 1/04

(52) U.S. Cl. CPC C02F 1/041
USPC 203/11; 203/10

(57) ABSTRACT

Methods including a) volatilizing at least a portion of contaminated water contained in a contaminated water reservoir and thereby generating volatilized water, the contaminated water reservoir being fluidly coupled to a water generator reservoir; b) conveying the volatilized water to the water generator reservoir; c) cooling the volatilized water in the water generator reservoir and thereby generating purified water, substantially dehumidified gas, and heat; and d) conveying at least one of the substantially dehumidified gas and the heat to the contaminated water reservoir.

### BACKGROUND

The present invention generally relates to water purification and extraction technology. More specifically, the present invention relates to apparatuses and methods related to extraction and purification of water from alternative sources.

Fresh water is an important resource in a large number of common daily uses (e.g., potable water) as well as numerous industrial applications including oilfield operations, agriculture, and the like. For example, subterranean treatment fluids are often aqueous-based and require large volumes (e.g., tens of thousands of gallons per day) of water. The water types that are typically used in subterranean treatment fluids include, but are not limited to, fresh water, saltwater, brine, seawater, weighted brine, and the like.

As used herein, the term “fresh water” refers to water with relatively low salinity, that is, fresh water generally contains low concentrations of dissolved salts. Fresh water can be defined as water with less than about 500 ppm of dissolved salts. In other instances, fresh water can be defined as water with less than about 1000 ppm, 2000 ppm, or 3000 ppm of dissolved salts. Fresh water can come from any number of sources including, but not limited to, rivers, lakes, wetlands, aquifers, and the like.

While fresh water is sometimes abundant, there are certain situations, particularly in oilfield applications, in which sources for fresh water are lacking. For example, drilling may be taking place in a remote region which lacks a fresh water source and the delivery of fresh water via trucking may be difficult or cost prohibitive. In other regions, acquiring fresh water may be difficult for legal and/or political reasons.

For these reasons, technologies that take advantage of alternative water sources have been developed. These include atmospheric water generators which are used to extract water from ambient air. However, there are several issues with these conventional atmospheric water generators and their related approaches. For example, atmospheric water generators are primarily used in residences, offices, or other low scale uses. To date, few, if any, large scale atmospheric water generators capable of generating tens of thousands of gallons of water per day have been developed. Thus, the throughput/footprint ratios, efficiencies, and/or operating expenses may need to be improved before atmospheric water generators can be applied to large scale operations. Moreover, conventional atmospheric water generators typically do not work well under certain atmospheric conditions, for example, low temperature (below 18.3° C.) and low humidity (below 30%).

Conventional distillation processes encounter distillation difficulties. Specifically, conventional distillation processes typically use a solid element or surface as a source of heat transfer. The temperature of the solid element must be above the boiling point of water in order to effectively provide distillation. However, the temperature of the solid element in conventional atmospheric water generators is often increased above the boiling point of water in order to speed the distillation process and meet demand. However, the increase in process speed may be accompanied by the undesirable precipitation of slats, minerals, and heavy metals, inducing scale build-up on the solid element and a decrease in heat transfer efficiency over time.

### SUMMARY OF THE INVENTION

The present invention generally relates to water purification and extraction technology. More specifically, the present invention relates to apparatuses and methods related to extraction and purification of water from alternative sources.

In some embodiments, the present invention provides methods comprising: a) volatilizing at least a portion of contaminated water contained in a contaminated water reservoir and thereby generating volatilized water, the contaminated water reservoir being fluidly coupled to a water generator reservoir; b) conveying the volatilized water to the water generator reservoir; c) cooling the volatilized water in the water generator reservoir and thereby generating purified water, substantially dehumidified gas, and heat; and d) conveying at least one of the substantially dehumidified gas and the heat to the contaminated water reservoir.

In other embodiments, the present invention provides methods comprising: a) volatilizing at least a portion of contaminated water contained in a contaminated water reservoir and thereby generating volatilized water, the contaminated water reservoir being fluidly coupled to a water generator reservoir; b) conveying the volatilized water to the water generator reservoir, the water generator reservoir also being fluidly coupled to a purified water reservoir; c) cooling the volatilized water in the water generator reservoir and thereby generating purified water, substantially dehumidified gas, and heat; d) conveying the purified water to the purified water reservoir; and e) conveying at least one of the substantially dehumidified gas and the heat to the contaminated water reservoir.

In still other embodiments, the present invention provides methods comprising: a) receiving and compressing ambient air in a compressor to generate compressed ambient air, the compressor being fluidly coupled to a water generator reservoir; b) conveying the compressed ambient air to the water generator reservoir, the water generator reservoir also being fluidly coupled to a purified water reservoir; c) cooling the compressed ambient air in the water generator reservoir and thereby generating water, substantially dehumidified air, and heat; and d) conveying the water to the purified water reservoir.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates an apparatus and a water extraction/purification process, according to one or more embodiments of the present invention, as described in Example 1.

FIG. 2 illustrates another apparatus and a water extraction/purification process, according to one or more embodiments of the present invention, as described in Example 2.

FIG. 3 illustrates another apparatus and a water extraction/purification process, according to one or more embodiments of the present invention, as described in Example 3.

### DETAILED DESCRIPTION

The present invention generally relates to water purification and extraction technology. More specifically, the present invention relates to apparatuses and methods related to extraction and purification of water from alternative sources.

The present invention provides a number of advantages. In one or more embodiments, the present invention provides alternative sources for fresh water and/or provides purification of contaminated water (e.g., produced water) to high standards for discharge in a publically owned treatment works (POTW), the environment, and/or use for other purposes such as potable water, reuse in subterranean treatment fluids, and the like.

The present invention utilizes a hot gas or a recycled hot gas and the surface of gas bubbles as a source for heat transfer, rather than a solid element heated to or above the boiling point of water. In doing so, the present invention avoids the potential of adverse scale build-up affecting heat transfer across the heat transfer surface area. Additionally, utilizing the surface of gas bubbles as a source for heat transfer provides a larger surface area for contact with contaminated water than a solid element is typically capable of providing. Furthermore, the liquid water from the contaminated water transfers to the gas bubbles of the present invention more effectively through bubble interfaces and drives efficiencies in the water purification and extraction process rate versus process throughput to yield higher conversions than using solid element distillation procedures.

As used herein, the term “contaminated water” generally refers to water that has relatively high concentrations of dissolved salts, such as sodium chloride, potassium chloride, calcium chloride, barium chloride, strontium chloride, a bromide salt, sulfate salts, phosphate salts, as compared to fresh water. In some cases, contaminated water may have a dissolved salt concentration at or above 3000 ppm. Contaminated water may also comprise biological contaminants (e.g., bacteria), organic contaminants (e.g., detergents, fats, grease, insecticides, herbicides, hydrocarbons, chlorinated solvents), macroscopic contaminants (paper, plastic, food waste), and the like.

In one or more embodiments, a key advantage of the present invention is that, unlike many conventional methods, the water generator reservoir (i.e., the component that purifies or extracts water) will generally not encounter the contaminants. Exemplary examples of contaminated water include, but are not limited to, produced water, leachate, flow back, and the like. As used herein, the term “produced water” generally refers to water that typically lies adjacent hydrocarbons in a subterranean formation and that is produced along with the hydrocarbons (e.g., oil and gas).

In one or more embodiments, the present invention may purify contaminated water with higher efficiencies and throughput/footprint ratio as compared to conventional purification methods. In one or more embodiments, the present invention may purify the produced water out in the oilfield, which may be disposed of or recycled in subsequent subterranean operations (e.g., in subterranean treatment fluids). In one or more embodiments, the present invention provides a renewable water source that is primarily independent of environmental conditions (e.g., temperature, humidity, etc.).

Some embodiments provide a method comprising: a) providing a water generator reservoir, and a contaminated water reservoir that comprises contaminated water, wherein the water generator reservoir is fluidly connected to the contaminated water reservoir; b) volatilizing at least a portion of the contaminated water in the contaminated water reservoir to form volatilized water; c) allowing the volatilized water to be transported to the water generator reservoir; d) cooling the volatilized water in the water generator reservoir thereby generating purified water, substantially dehumidified gas, and heat; and e) allowing at least one of the substantially dehumidified gas and the heat to be transported to the contaminated water reservoir. In some embodiments, steps b), c), d), and e) are repeated as part of a cycle. Optionally, the method may further comprise: f) separating the purified water from the water generator reservoir. Optionally, the method may further comprise: removing a precipitated salt formed in the contaminated water reservoir.

Water generator reservoirs useful in the present invention may be used to extract and/or purify water from sources such as ambient air or contaminated water. As used herein, water that has been purified or “purified water” may refer to water that has been extracted from ambient air and/or to water that has been purified from a contaminated water source. The purified water will typically have lower concentration of contaminants compared to the contaminated water.

Specifically, the water generator reservoir is any type of containment or vessel that is able to store large volumes of fluids (e.g., ambient air, volatilized water). In some embodiments, the water generator reservoir may be fluidly coupled or otherwise attached to a compressor used to compress ambient air and/or volatilized water, which should allow larger masses of ambient air and/or volatilized water to be extracted and/or purified. While any compressor that is compatible with one or more embodiments may be used, an exemplary compressor may be one that is driven by a motor that may be fueled by propane or electrically driven. Suitable compressors include, but are not limited to, reciprocating compressors, rotary compressors, centrifugal compressors, axial compressors, and the like.

The water generator reservoir may also generally include and/or is otherwise fluidly coupled to a cooling means configured to dehumidify the ambient air and/or volatilized water that is contained within the water generator reservoir. Suitable cooling means include, but are not limited to, refrigerants, refrigerated coils, fans, condensing coils, heat exchangers, combinations thereof, and the like. During the dehumidification process, the water generator reservoir may produce dehumidified air and/or heat. Optionally, the water generator reservoir may include and/or is coupled to an evaporator, a pump, an air filter, and the like.

During the dehumidification process, the purified water is generally extracted from any gas contained in the water generator reservoir. In some embodiments, the purified water may undergo further treatment. Suitable examples of treatment include, but are not limited to, exposing the purified water to UV light, filtering the purified water, desalinating the purified water, subjecting the purified water to reverse osmosis, distilling the purified water, and combinations thereof. In some embodiments, the resulting purified water may be potable water and therefore safe for human consumption. In other embodiments, however, the purified water may be separated for disposal, sewage treatment, recycled in subterranean treatment fluids, and the like. The subterranean treatment fluid may be any fluid that uses water. Suitable examples of subterranean treatment fluids include, but are not limited to, drilling fluids, fracturing fluids, completion fluids, and the like.

Contaminated water reservoirs useful in the present invention may be used to store or contain contaminated water. The contaminated water reservoir may be any containment or vessel compatible with one or more embodiments and is generally fluidly connected (e.g., by a conduit) to the water generator reservoir. In some embodiments, a plurality of conduits may be used to fluidly connect the contaminated water reservoir and the water generator reservoir. In at least one embodiment, the conduits fluidly connecting the contaminated water reservoir and the water generator reservoir may be unidirectional (i.e., matter is transported in one direction or primarily in one direction).

In some embodiments, the contaminated water reservoir may be generally coupled to a volatilizer. The volatilizer is an apparatus that can at least partially volatilize the contaminated water, thereby generating volatilized water. As used herein, the term “volatilizer” generally refers to an apparatus that can volatilize a composition. As used herein, “volatilize” (or variants, such as “volatilized” or “volatilizing”) may refer to a process of causing a fluid to pass off in vapor without raising the temperature of the composition to its boiling point. In one embodiment, bubbles of dehumidified gas can be generated at a surface of the contaminated reservoir, for example, the bottom surface of the contaminated water reservoir, by flowing the dehumidified gas from the water generator reservoir through a surface (in contact with the contaminated water) defining a plurality of holes, orifices, valves, nozzles, etc. The bubbles of dehumidified gas may then be configured to migrate through the contaminated water, simultaneously collecting volatilized water. The bubbles naturally separate from the contaminated water as a result of the buoyancy of a gas in water as dictated by the density difference between the gas and the water. The bubbles contain humidified gases as the bubbles exit the contaminated water at the top surface of the contaminated water. Once the bubbles exit the contaminated water, the bubbles collectively join as a homogeneous gas mixture containing volatilized water. Thus, a bubble may act as a transporter of humidified gas. To facilitate volatilizing water from the contaminated water, bubbles with high surface area to volume ratios may be used. To further facilitate volatilizing water from contaminated water, heated bubbles may be used. As used herein, the term “dehumidify” or “dehumidified” refers to removing moisture from a substance, such as by cooling or compression. As used herein, the term “dehumidified gas” refers to removing moisture from a gas (e.g., air). Suitable examples of volatilizers include, but are not limited to, diffusers, bubblers, gas outlets, and the like.

While at least one embodiment described herein relates to bubblers, any volatilizer that is compatible with one or more embodiments may be used. Once humidified bubbles collectively join to create the homogeneous gas mixture containing volatilized water, the gas mixture can be transported to the water generator reservoir through one of the conduits that fluidly connects the contaminated water reservoir with the water generator reservoir. The gas mixture will generally comprise humidified gas while being substantially free of contaminants. Thus, contaminants such as precipitated salts will typically form and be confined to the contaminated water reservoir.

As described above, dehumidified gas and/or heat may be generated during the dehumidification process that takes place in the water generator reservoir. This dehumidified gas or heat, or both, may be subsequently transported back to the contaminated water reservoir through one of the conduits or by other suitable means. The dehumidified gas and heat may be used to generate new bubbles in the contaminated water reservoir at relatively higher efficiencies and throughput/footprint ratios.

Some embodiments provide a method comprising: a) providing a water generator reservoir, a purified water reservoir, and a contaminated water reservoir that comprises produced water, wherein the water generator reservoir is fluidly connected to the purified water reservoir and the contaminated water reservoir; b) volatilizing at least a portion of the contaminated water in the contaminated water reservoir to form volatilized water; c) allowing the volatilized water to be transported to the water generator reservoir; d) cooling the volatilized water in the water generator reservoir thereby generating purified water, substantially dehumidified gas, and heat; e) allowing the purified water to be transported to the purified water reservoir; and f) allowing at least one of the substantially dehumidified gas and the heat to be transported to the contaminated water reservoir. In some embodiments, steps b), c), d), e), and f) are repeated.

Some embodiments provide a method comprising: a) providing a water generator reservoir, a compressor, a clean water reservoir, wherein the water generator reservoir is fluidly connected to the purified water reservoir; b) compressing the ambient air to form compressed ambient air; c) collecting the compressed ambient air in the water generator reservoir; d) cooling the compressed ambient air in the water generator reservoir thereby generating water, substantially dehumidified air, and heat; and e) transporting the water to the purified water reservoir. In some embodiments, steps b), c), d), and e) are repeated. In some embodiments, the compressor is attached or otherwise coupled to the water generator reservoir.

Some embodiments provide a system for dehumidifying gas comprising: a contaminated water reservoir coupled to a volatilizer that is configured to volatilize water contained in the contaminated water reservoir to form volatilized water; a water generator reservoir coupled to a dehumidifier that is configured to extract water from the volatilized water; and at least one fluid connection between the contaminated water reservoir and the water generator reservoir, the fluid connection configured to allow transport of heat, dehumidified gas, and the volatilized water. Optionally, the system may further comprise: a purified water reservoir fluidly connected (e.g., by a conduit) to the water generator reservoir.

Some embodiments provide a system for dehumidifying gas comprising: a contaminated water reservoir coupled to a volatilizer that is configured to volatilize water contained in the contaminated water reservoir to form volatilized water; a water generator reservoir coupled to a dehumidifier that is configured to extract water from the volatilized water, wherein the water generator reservoir is fluidly connected to the contaminated water reservoir; and a purified water reservoir configured to store extracted water, wherein the purified water reservoir is fluidly connected to the water generator reservoir.

Some embodiments provide a system for dehumidifying ambient air comprising: a water generator reservoir coupled to a dehumidifier that is configured to extract water from ambient air; a compressor coupled to the water generator reservoir, the compressor configured to compress the ambient air; and a purified water reservoir configured to store extracted water, wherein the purified water reservoir fluidly communicates with the water generator reservoir.

To facilitate a better understanding of the present invention, the following examples of preferred or representative embodiments are given. In no way should the following examples be read to limit, or to define, the scope of the invention.

### Example 1

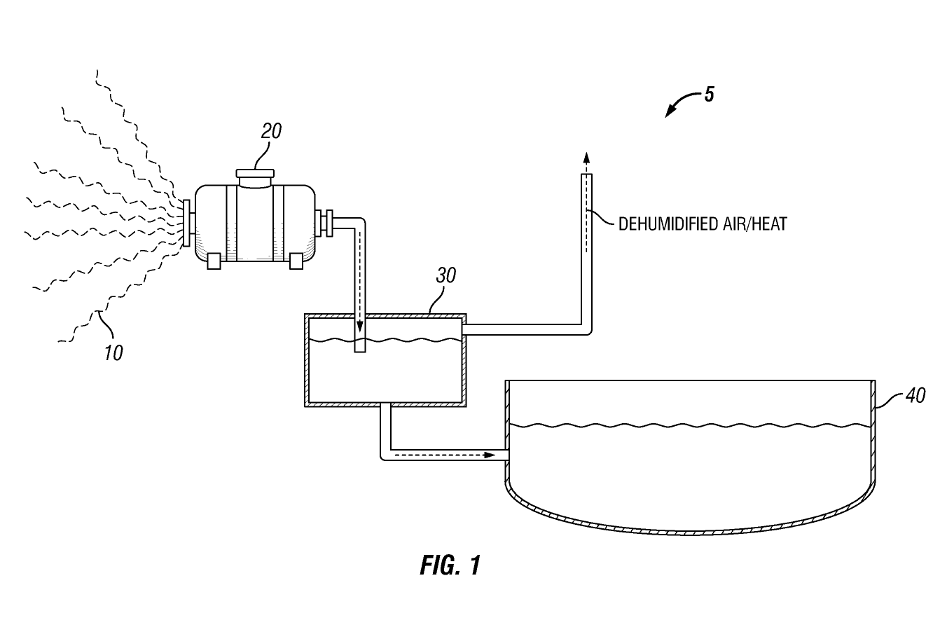

FIG. 1 shows an apparatus 5, according to one or more embodiments of the present invention. The apparatus includes a compressor 20, a water generator reservoir 30, and a purified water reservoir 40. In the embodiment shown, the water generator reservoir 30 is fluidly connected to both the compressor 20 and the purified water reservoir 40.

As shown in FIG. 1, the compressor 20 may be configured to receive and compress ambient air 10, for example, in order to generate compressed ambient air. The compressed ambient air may then be conveyed to the water generator reservoir 30. In the water generator reservoir 30, the compressed ambient air may be dehumidified by cooling in order to extract purified water and release dehumidified air and heat back into the ambient air 10. The purified water is separated and conveyed to the purified water reservoir 40 where it may be stored, for example.

### Example 2

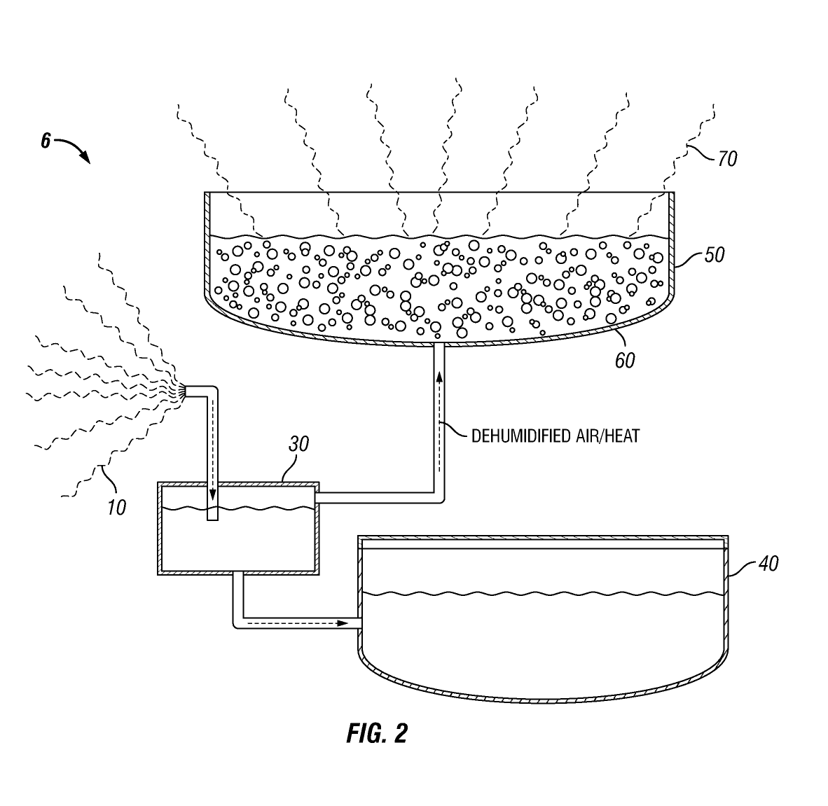

FIG. 2 shows another apparatus 6, according to one or more embodiments of the present invention. The apparatus includes a water generator reservoir 30, a purified water reservoir 40, and a contaminated water reservoir 50. In the embodiment shown, the water generator reservoir 30 is fluidly connected to the purified water reservoir 40 and the contaminated water reservoir 50.

As shown in FIG. 2, the water generator reservoir 30 may be configured to receive and dehumidify the ambient air 10, thereby resulting in the generation of purified water and dehumidified air and heat. The purified water may be conveyed to the purified water reservoir 40, and the dehumidified air and heat may be ejected from the water generator reservoir 30 and received for recycling in the contaminated water reservoir 50 which contains produced water. In some embodiments, as generally discussed above, the dehumidified air and the heat helps to volatilize the produced water by forming bubbles 60 that result in the release of humidified air 70. Example 2 illustrates the atmospheric cycle mode of the present invention.

### Example 3

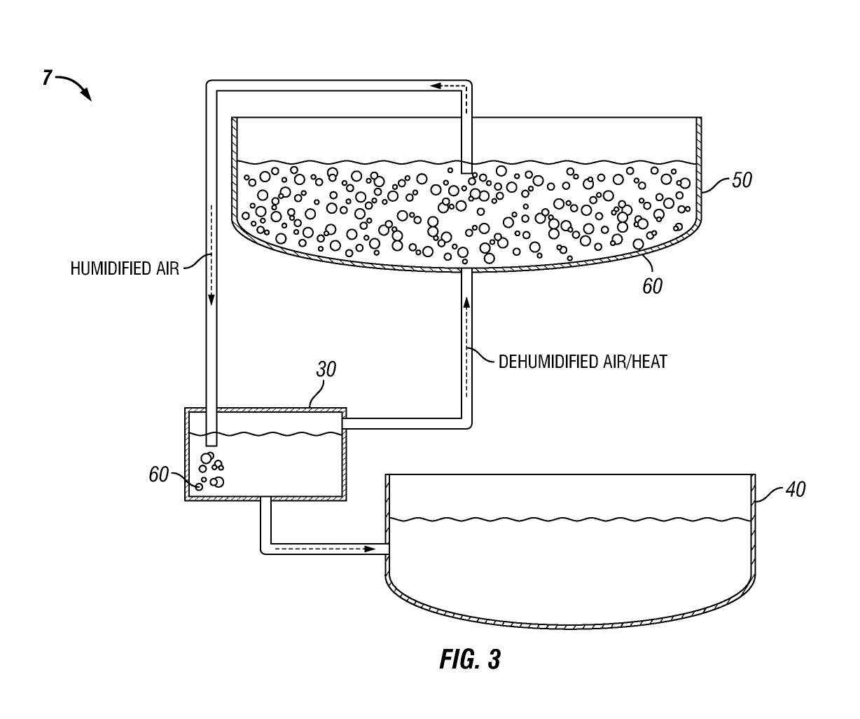

FIG. 3 shows another apparatus 7, according to one or more embodiments of the present invention. The apparatus includes a water generator reservoir 30, a purified water reservoir 40, and a contaminated water reservoir 50. In the embodiment shown, the water generator reservoir 30 may be fluidly connected to both the purified water reservoir 40 and the contaminated water reservoir 50.

As shown in FIG. 3, the contaminated water reservoir 50 contains produced water that may be volatilized which results in the formation of bubbles 60 containing humidified air. The bubbles 60 may then be conveyed to the water generator reservoir 30 where the humidified air is conveyed back into water generator reservoir 30. The humidified air contained in the water generator reservoir 30 is dehumidified, thereby resulting in purified water and dehumidified air and heat. The purified water may then be conveyed to the purified water reservoir 40 for storage, while the dehumidified air and heat may be conveyed to the contaminated water reservoir 50 for recycling back into the produced water. Example illustrates the internal cycle mode of the present invention.

Some embodiments of the present invention comprise methods including the steps of a) providing a water generator reservoir, and a contaminated water reservoir that comprises contaminated water, wherein the water generator reservoir is fluidly connected to the contaminated water reservoir; b) volatilizing at least a portion of the contaminated water in the contaminated water reservoir to form volatilized water; c) allowing the volatilized water to be transported to the water generator reservoir; d) cooling the volatilized water in the water generator reservoir thereby generating purified water, substantially dehumidified gas, and heat; and, e) allowing at least one of the substantially dehumidified gas and the heat to be transported to the contaminated water reservoir.

Other embodiments of the present invention include methods comprising: a) providing a water generator reservoir, a compressor, and a clean water reservoir, wherein the water generator reservoir is fluidly connected to the purified water reservoir; b) compressing the ambient air to form compressed ambient air; c) collecting the compressed ambient air in the water generator reservoir; d) cooling the compressed ambient air in the water generator reservoir thereby generating water, substantially dehumidified air, and heat; and, e) transporting the water to the purified water reservoir.

Other embodiments of the present invention include methods comprising: a) providing a water generator reservoir, a purified water reservoir, and a contaminated water reservoir that comprises produced water, wherein the water generator reservoir is fluidly connected to the purified water reservoir and the contaminated water reservoir; b) volatilizing at least a portion of the contaminated water in the contaminated water reservoir to form volatilized water; c) allowing the volatilized water to be transported to the water generator reservoir; d) cooling the volatilized water in the water generator reservoir thereby generating purified water, substantially dehumidified gas, and heat; e) allowing the purified water to be transported to the purified water reservoir; and, f) allowing at least one of the substantially dehumidified gas and the heat to be transported to the contaminated water reservoir.

In some cases, steps b), c), d), and e) or steps b), c), d), e), and f) may be repeated. Also, the methods may include the additional step of separating the purified water from the water generator reservoir. The purified water may then be separated for disposal or sewage treatment. The contaminated water may comprise a salts such as sodium chloride, potassium chloride, calcium chloride, barium chloride, strontium chloride, a bromide salt, or combinations thereof and may be produced water from a subterranean formation. IN some cases, the purified water may undergo further treatment such as UV light, filtering, desalination, reverse osmosis, distillation, or some combination thereof. In methods using a compressor, the compressor may be attached to the water generator reservoir.

Other embodiments of the present invention include systems for dehumidifying gas comprising: a contaminated water reservoir coupled to a volatilizer that is configured to volatilize water contained in the contaminated water reservoir to form volatilized water; a water generator reservoir coupled to a dehumidifier that is configured to extract water from the volatilized water; and, at least one fluid connection between the contaminated water reservoir and the water generator reservoir, the fluid connection configured to allow transport of heat, dehumidified gas, and the volatilized water.

Other embodiments of the present invention include systems for dehumidifying gas comprising: a contaminated water reservoir coupled to a volatilizer that is configured to volatilize water contained in the contaminated water reservoir to form volatilized water; a water generator reservoir coupled to a dehumidifier that is configured to extract water from the volatilized water, wherein the water generator reservoir is fluidly connected to the contaminated water reservoir; and, a purified water reservoir configured to store extracted water, wherein the purified water reservoir is fluidly connected to the water generator reservoir.

Other embodiments of the present invention include systems for dehumidifying ambient air comprising: a water generator reservoir coupled to a dehumidifier that is configured to extract water from ambient air; a compressor coupled to the water generator reservoir, the compressor configured to compress the ambient air; and, a purified water reservoir configured to store extracted water, wherein the purified water reservoir is connected by a fluidic connection to the water generator reservoir.

The systems may further comprise a purified water reservoir fluidly connected to the water generator reservoir. The volatilizer may include a diffuser, a bubbler, a gas outlet, or any combination thereof. The dehumidifier may include a refrigerant, a refrigerated coil, a fan, a condensing coil, or any combination thereof. The water generator reservoir may be coupled to a compressor configured to compress the volatilized water and further serve to dehumidify. The systems may further comprise: a pump, an evaporator, a condenser, a UV light source, a filter, a desalination apparatus, a reverse osmosis apparatus, a distillation apparatus, and any combination thereof.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
a) volatilizing at least a portion of contaminated water contained in a contaminated water reservoir and thereby generating volatilized water, the contaminated water reservoir being fluidly coupled to a water generator reservoir;
b) conveying the volatilized water to the water generator reservoir;
c) cooling the volatilized water in the water generator reservoir and thereby generating purified water, substantially dehumidified gas, and heat; and
d) conveying at least one of the substantially dehumidified gas and the heat to the contaminated water reservoir.

2. The method of claim 1, further comprising repeating steps a), b), c), and d).

3. The method of claim 1, wherein the water generator reservoir is further fluidly coupled to a dehumidifier and step c) further comprises dehumidifying the volatized water so as to separate the purified water from the substantially dehumidified gas and the heat within the water generator reservoir.

4. The method of claim 1, wherein the water generator reservoir is fluidly coupled to a compressor and step c) further comprises compressing the volatized water within the water generator reservoir.

5. The method of claim 1, wherein the water generator reservoir further includes at least one selected from the group consisting of a pump, a condenser, an evaporator, a filter, and any combination thereof.

6. The method of claim 1, wherein the volatilized water is volatilized by a volatilizer fluidly coupled to the contaminated water reservoir.

7. The method of claim 1, further comprising treating the purified water with a treatment selected from the group consisting of: UV light exposure, filtering, desalination, reverse osmosis, distillation, and any combination thereof.

8. A method comprising:
a) volatilizing at least a portion of contaminated water contained in a contaminated water reservoir and thereby generating volatilized water, the contaminated water reservoir being fluidly coupled to a water generator reservoir;
b) conveying the volatilized water to the water generator reservoir, the water generator reservoir also being fluidly coupled to a purified water reservoir;
c) cooling the volatilized water in the water generator reservoir and thereby generating purified water, substantially dehumidified gas, and heat;
d) conveying the purified water to the purified water reservoir; and
e) conveying at least one of the substantially dehumidified gas and the heat to the contaminated water reservoir.

9. The method of claim 8, further comprising repeating steps a), b), c), d), and e).

10. The method of claim 8, wherein the water generator reservoir is further fluidly coupled to a dehumidifier and step c) further comprises dehumidifying the volatized water so as to separate the purified water from the substantially dehumidified gas and the heat within the water generator reservoir.

11. The method of claim 8, wherein the water generator reservoir is fluidly coupled to a compressor and step c) further comprises compressing the volatized water within the water generator reservoir.

12. The method of claim 8, wherein the water generator reservoir further includes at least one selected from the group consisting of a pump, a condenser, an evaporator, a filter, and any combination thereof.

13. The method of claim 8, wherein the volatilized water is volatilized by a volatilizer fluidly coupled to the contaminated water reservoir.

14. The method of claim 8, further comprising treating the purified water with a treatment selected from the group consisting of: UV light exposure, filtering, desalination, reverse osmosis, distillation, and any combination thereof.

15. A method comprising:
a) receiving and compressing ambient air in a compressor to generate compressed ambient air, the compressor being fluidly coupled to a water generator reservoir;
b) conveying the compressed ambient air to the water generator reservoir, the water generator reservoir also being fluidly coupled to a purified water reservoir;
c) cooling the compressed ambient air in the water generator reservoir and thereby generating water, substantially dehumidified air, and heat; and
d) conveying the water to the purified water reservoir.

16. The method of claim 15, further comprising repeating steps a), b), c), and d).

17. The method of claim 15, wherein the water generator reservoir is further fluidly coupled to a dehumidifier and step c) further comprises dehumidifying the volatized water so as to separate the purified water from the substantially dehumidified air and the heat within the water generator reservoir.

18. The method of claim 15, wherein the water generator reservoir further includes at least one selected from the group consisting of a pump, a condenser, an evaporator, a filter, and any combination thereof.

19. The method of claim 15, further comprising step e) conveying at least one of the substantially dehumidified air and the heat to a contaminated water reservoir fluidly coupled to the water generator reservoir.

20. The method of claim 15, further comprising treating the purified water with a treatment selected from the group consisting of: UV light exposure, filtering, desalination, reverse osmosis, distillation, and any combination thereof.
